(19) United States
(12) Patent Application Publication
(10) Pub. No.: US 2007/0056411 A1
(43) Pub. Date: Mar. 15, 2007

(54) Wrench

(76) Inventor: Steven Carlson, Rochester, MI (US)

Correspondence Address: STEVEN CARLSON, 1421 MILL RACE, ROCHESTER, MI, 48306, US

(21) Appl. No.: 11/224,211

(22) Filed: Sep. 12, 2005

(51) Int. Cl. B25B 13/02; B25B 13/58

(52) U.S. Cl. 81/125; 81/184

(57) ABSTRACT

A wrench includes at least one working end being configured as a circumferentially continuous box and a stop plate configured to be locatable in a working position external from and adjacent to the circumferentially continuous box. The stop plate may include opposed first and second ends, where the first end may be configured to operably engage a shank and the second end may be configured as a plate. The plate may be sized to substantially conform with the circumferentially continuous box and define an opening substantially concentric with the circumferentially continuous box when the stop plate is in the working position.

### BACKGROUND

This application relates to hand tools such as wrenches including open ended, closed or box ended, and combination wrenches. Such wrenches can be employed for turning threaded machine nuts and bolts for example.

### BRIEF DESCRIPTION OF THE DRAWINGS

The accompanying drawings illustrate various example embodiments of aspects or multiple aspects of the application. It will be appreciated that the drawings may omit particular elements not needed for understanding of the particular aspects under discussion and that elements may be shown enlarged or reduced in relation to other components to facilitate discussion. Elements may not be drawn to scale.

FIG. 1 illustrates a stop plate suitable to practice aspects of the application.

FIG. 2 illustrates a stop plate operably attached to a wrench.

FIG. 3 illustrates an alternate embodiment of a stop plate operably attached to a wrench.

### DETAILED DESCRIPTION

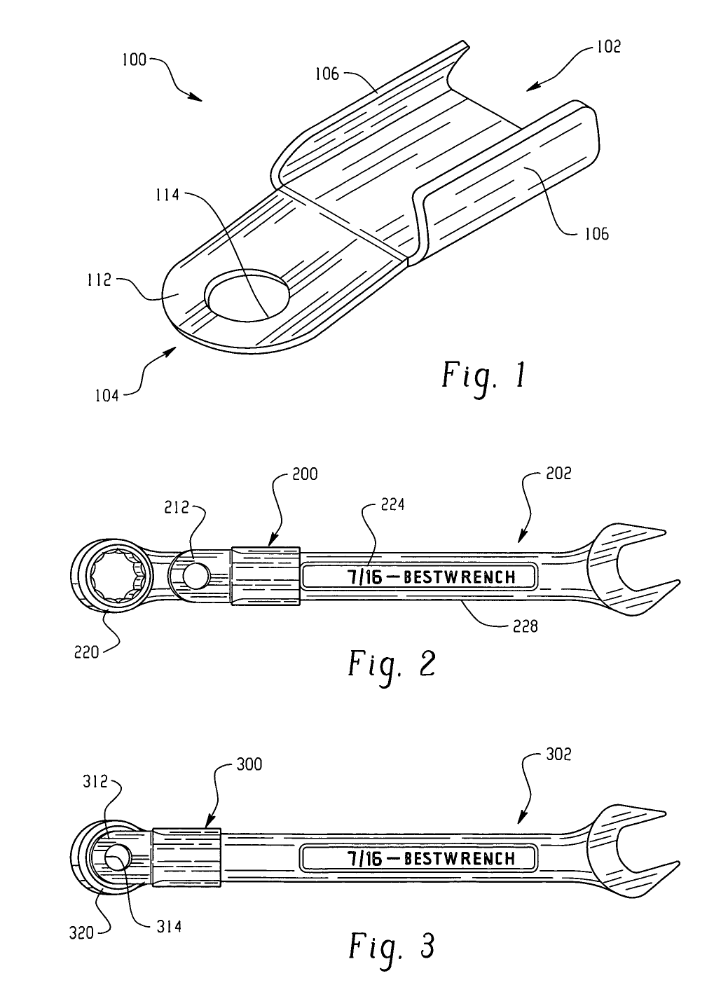

FIG. 1 illustrates an example stop plate 100 upon which example systems and methods described herein, and equivalents, can operate. The stop plate 100 includes opposed first and second ends 102, 104. First end 102 includes attachment flanges 106 adapted to operably affix the stop plate 100 to the shank of a wrench (not shown). The first end 102 and flanges 106 may be formed from rigid material such as metal, or may be formed from resilient material such as plastic that may permit repeated removal and reapplication of the stop plate 100 to the wrench without the need for additional tools. Second end 104 includes a plate 112 shaped to correspond to the wrench upon which the stop plate 100 is designed. The plate 112 defines a central opening 114 through which threaded rod may pass while the wrench is in use.

FIG. 2 illustrates an example stop plate 200 coupled with a wrench 202. As illustrated, the stop plate 200 is in a retracted or non-working position where plate 212 does not overlay box end 220. In one embodiment, a raised label area 224 restricts the stop plate 200 from moving more than a determined distance along the shank 228. In other embodiments retaining pins, magnetic inserts or other temporary locking mechanisms may be employed to retain stop plate in the retracted position.

FIG. 3 illustrates an example stop plate 300 coupled with a wrench 302. As illustrated, the stop plate is in an advanced or working position where plate 312 overlays box end 320. In the illustrated advanced position, central opening 314 is orientated substantially concentrically with box end 320. In operation, a work piece, such as a nut or a bolt head, is prevented from passing through or slipping over the box end 320 by plate 312. In another embodiment, a work piece may be threaded over complementarily threaded rod of long lengths by action of the central opening 314 permitting the threaded rod to pass through the stop plate 300. In this embodiment, the threaded rod passing through stop plate 300 also acts to keep the wrench and working end 320 engaged with the nut or other work piece.

It can now be appreciated that the stop plate 300 shown may include opposing plates for each end of a dual ended wrench such as a combination wrench 302. Alternately, combination wrenches may employ separate stop plates configured for particulars such as angle, orientation and size of each end. Stop plates may be slidably disposed between working and disengaged positions, or between ends of a combination wrench. Alternately, the stop plate may be disposed fixedly in a working position over the working end, closed box or open box, desired. The stop plate may be formed separate or together with a wrench from a variety of manufacturing processes including but not limited to injection or other plastic molding, metal stamping, drop forging and the like.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A wrench comprising:
a working end disposed at one end of a shank, the working end being configured as a circumferentially continuous box; and
a stop plate configured to be locatable in a working position external from and adjacent to the circumferentially continuous box, the stop plate including opposed first and second ends, the first end being configured to operably engage the shank and the second end being configured as a plate sized to substantially conform with the circumferentially continuous box and define an opening substantially concentric with the circumferentially continuous box when the stop plate is in the working position.

2. The wrench as set forth in claim 1, where the first end engages the shank permitting slidable movement of the stop plate between the working position and a disengaged position.

3. The wrench as set forth in claim 1, further comprising:
a second working end opposite the first working end, the second working end being configured as a second circumferentially continuous box; and
a second stop plate configured to be locatable in a second working position external from and adjacent to the second circumferentially continuous box, the second stop plate including opposed first and second ends, the first end being configured to operably engage the shank supporting the first and second working ends and the second end being configured as a plate sized to substantially conform with the second circumferentially continuous box and define an opening substantially concentric with the second circumferentially continuous box when the second stop plate is in the second working position.

4. The wrench as set forth in claim 1, further comprising:
a second working end opposite the first working end, the second working end being configured as an open end box; and
a second stop plate configured to be locatable in a second working position external from and adjacent to the open end box, the stop plate including opposed first and second ends, the first end being configured to operably engage the shank supporting the first and second working ends and the second end being configured as a plate sized to prevent a work piece from passing through the second working end.

5. (canceled)

6. (canceled)

7. A kit comprising:
a set of wrenches each including a working end formed as a continuous box supported by a shank; and
a set of stop plates each configured to be locatable external from and adjacent to the working end on at least one of the set of wrenches, each stop plate including opposed first and second ends, the first end being configured to engage a shank and the second end being configured as a plate sized to prevent a work piece from passing through the working end, the plate defining a central opening configured for concentric positioning with the continuous box.

8. An apparatus comprising:
a stop plate configured to be locatable on a wrench external from and adjacent to a circumferentially continuous box, the stop plate including opposed first and second ends, the first end being configured to operably engage a shank supporting the circumferentially continuous box and the second end being configured as a plate sized to substantially conform with the circumferentially continuous box and define an opening substantially concentric with the circumferentially continuous box when the stop plate is disposed external from and adjacent to the circumferentially continuous box.

9. The apparatus as set forth in claim 8, where the stop plate first end comprises resilient material capable of temporary deformation during removal from and application to the shank.
